(19) United States
(12) Patent Application Publication
(10) Pub. No.: US 2024/0387111 A1
(43) Pub. Date: Nov. 21, 2024

(54) MULTILAYER CERAMIC CAPACITOR

(71) Applicant: Murata Manufacturing Co., Ltd., Nagaokakyo-shi (JP)

(72) Inventors: Ryutaro YAMATO, Nagaokakyo-shi (JP); Tadateru YAMADA, Nagaokakyo-shi (JP); Shoichiro SUZUKI, Nagaokakyo-shi (JP)

(21) Appl. No.: 18/788,282

(22) Filed: Jul. 30, 2024

Related U.S. Application Data
(63) Continuation of application No. PCT/JP2023/010559, filed on Mar. 17, 2023.

(30) Foreign Application Priority Data
Mar. 30, 2022 (JP) 2022-055678

(51) Int. Cl. H01G 4/232; H01G 4/012; H01G 4/30

(52) U.S. Cl. CPC H01G 4/2325; H01G 4/012; H01G 4/30

(57) ABSTRACT

A multilayer ceramic capacitor includes a capacitor body including dielectric layers, first and second inner electrodes, first and second principal surfaces, first and second side surfaces, and first and second end surfaces, first and second outer electrodes on at least the first principal surface and respectively electrically coupled to the first and second inner electrodes, and first and second bumps on a surface on a first principal surface side of the capacitor body and including one of Au, Cu, or Al. The outer electrodes are not on the second principal surface of the capacitor body. The first and second outer electrode respectively include first and second metal layers in contact with the first and second bumps and made of the same material. Thicknesses of the first and second bumps in the first direction are equal to or greater than about 4.5 μm.

### CROSS REFERENCE TO RELATED APPLICATIONS

This application claims the benefit of priority to Japanese Patent Application No. 2022-055678 filed on Mar. 30, 2022 and is a Continuation Application of PCT Application No. PCT/JP2023/010559 filed on Mar. 17, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

There has been known a method of mounting a semiconductor device on a substrate by ultrasonic joining. The ultrasonic joining is affected less by heat because metals are brought into solid-phase joining under the melting points, and thus has advantages such as a capability of reducing electrical resistance at a joined portion as compared to a case of joining by use of solder.

As one mounting method that utilizes the ultrasonic joining, Japanese Unexamined Patent Application Publication No. 2012-9599 discloses a method of electrically coupling a semiconductor device to a wiring component by applying ultrasonic waves to a bump between an electrode of the semiconductor device and the wiring component. To be more precise, the semiconductor device provided with the bump at its electrode is held by using a holder, and the held semiconductor device is brought closer to the wiring component on a stage, thus bringing the bump into contact with the wiring component. Subsequently, the holder is subjected to ultrasonic vibration while pressing the semiconductor device against the wiring component, thus transmitting the ultrasonic vibration to the bump and joining the electrode of the semiconductor device to the wiring component.

Here, it is conceivable to perform the above-described ultrasonic joining to a multilayer ceramic capacitor instead of the semiconductor device. As the multilayer ceramic capacitor, there has been known a structure in which outer electrodes are provided on surfaces of a capacitor body including a laminate of multiple dielectric layers and multiple inner electrodes, a pair of principal surfaces, a pair of side surfaces, and a pair of end surfaces. In particular, there has generally been known a multilayer ceramic capacitor having a structure in which outer electrodes are provided to the entirety of both end surfaces of a capacitor body such that the outer electrodes extend from both of the end surfaces and wrap around a pair of principal surfaces and a pair of side surfaces, respectively.

As a consequence of subjecting the multilayer ceramic capacitor having the above-described structure to the ultrasonic joining in accordance with the method disclosed in Japanese Unexamined Patent Application Publication No. 2012-9599, there might be a case in which cracks in the multilayer ceramic capacitor are caused.

### SUMMARY OF THE INVENTION

Example embodiments of the present invention provide multilayer ceramic capacitors that each reduce or prevent an occurrence of cracks even when ultrasonic joining is performed. A multilayer ceramic capacitor according to an example embodiment of the present invention includes a capacitor body including a laminate of a plurality of dielectric layers, a plurality of first inner electrodes, and a plurality of second inner electrodes. The capacitor body includes a first principal surface and a second principal surface opposed to each other in a first direction, a first side surface and a second side surface opposed to each other in a second direction orthogonal or substantially orthogonal to the first direction, and a first end surface and a second end surface opposed to each other in a third direction orthogonal or substantially orthogonal to the first direction and the second direction. A first outer electrode is provided on at least the first principal surface, and is electrically coupled to the first inner electrodes. A second outer electrode is provided on at least the first principal surface, and is electrically coupled to the second inner electrodes. A first bump is provided on a surface on a first principal surface side of the capacitor body, and includes one of Au, Cu, or Al. A second bump is provided on a surface on the first principal surface side of the capacitor body, and includes the same material as the first bump. The first outer electrode and the second outer electrode are not provided on the second principal surface of the capacitor body. The first outer electrode includes a first metal layer on at least a position that comes into contact with the first bump, and includes the same material as the first bump. The second outer electrode includes a second metal layer on at least a position that comes into contact with the second bump, and includes a same material as the second bump. A thickness of the first bump and a thickness of the second bump in the first direction are equal to or greater than about 4.5 μm.

In example embodiments of the present invention, the first outer electrode and the second outer electrode are provided on at least the first principal surface of the capacitor body, while the first outer electrode and the second outer electrode are not provided to the second principal surface. Meanwhile, the first bump is provided on the surface on the first principal surface side of the capacitor body of the surfaces of the first outer electrode, and the second bump is provided on the surface on the first principal surface side of the capacitor body of the surfaces of the second outer electrode. When the capacitor body is held with a holder such that a holding surface comes into contact with the second principal surface of the capacitor body in order to subject the above-described multilayer ceramic capacitors to ultrasonic joining, both of flat surfaces come into contact with each other between the holding surface and the second principal surface, and a contact area is therefore increased. Accordingly, when ultrasonic vibration is applied to the holder that holds the multilayer ceramic capacitor, the multilayer ceramic capacitor is vibrated in a direction parallel or substantially parallel to the principal surface of the capacitor body. Thus, stress concentration on the side surfaces, the end surfaces, and the like of the capacitor body is reduced so that an occurrence of cracks is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view schematically illustrating a multilayer ceramic capacitor according to a first example embodiment of the present invention.

FIG. 2 is a sectional view schematically illustrating a structure when the multilayer ceramic capacitor illustrated in FIG. 1 is sectioned along the II-II line.

FIG. 3 is a sectional view schematically illustrating a structure when the multilayer ceramic capacitor illustrated in FIG. 1 is sectioned along the III-III line.

FIG. 4 is a sectional view schematically illustrating a structure when the multilayer ceramic capacitor illustrated in FIG. 1 is sectioned along the IV-IV line.

FIG. 5 is a plan view for explaining a proportion of an area of a flat region relative to an area of a second principal surface of a capacitor body.

FIGS. 6A and 6B include diagrams for explaining an example of a method of subjecting a multilayer ceramic capacitor to ultrasonic joining, in which FIG. 6A illustrates a state of holding the multilayer ceramic capacitor with a holder, and FIG. 6B illustrates a state of bringing a first bump provided to a surface of a first outer electrode of the multilayer ceramic capacitor and a second bump provided to a surface of a second outer electrode of the multilayer ceramic capacitor into contact with land electrodes provided to a substrate.

FIG. 7A is a diagram illustrating a simulation result showing a direction of displacement and stress distribution of a multilayer ceramic capacitor according to an example embodiment of the present invention, and FIG. 7B is a perspective view illustrating the simulation result of the stress distribution of the multilayer ceramic capacitor according to the present example embodiment. FIG. 7C is a diagram illustrating a simulation result depicting a direction of displacement and stress distribution of a multilayer ceramic capacitor according to a comparative example, and FIG. 7D is a perspective view illustrating the simulation result of the stress distribution of the multilayer ceramic capacitor according to the comparative example.

FIG. 8 is a perspective view schematically illustrating a multilayer ceramic capacitor according to a second example embodiment of the present invention.

FIG. 9 is a sectional view schematically illustrating a structure when the multilayer ceramic capacitor illustrated in FIG. 8 is sectioned along the IX-IX line.

FIG. 10 is a sectional view schematically illustrating a structure when the multilayer ceramic capacitor illustrated in FIG. 8 is sectioned along the X-X line.

FIG. 11 is a perspective view schematically illustrating a multilayer ceramic capacitor according to a third example embodiment of the present invention.

FIG. 12 is a sectional view schematically illustrating a structure when the multilayer ceramic capacitor illustrated in FIG. 11 is sectioned along the XII-XII line.

FIG. 13 is a sectional view schematically illustrating a structure when the multilayer ceramic capacitor illustrated in FIG. 11 is sectioned along the XIII-XIII line.

FIG. 14 is a perspective view schematically illustrating a multilayer ceramic capacitor according to a fourth example embodiment of the present invention.

FIG. 15 is a sectional view schematically illustrating a structure when the multilayer ceramic capacitor illustrated in FIG. 14 is sectioned along the XV-XV line.

FIG. 16 is a sectional view schematically illustrating a structure when the multilayer ceramic capacitor illustrated in FIG. 14 is sectioned along the XVI-XVI line.

### DETAILED DESCRIPTION OF THE EXAMPLE EMBODIMENTS

Features of the present invention will be specifically described with reference to example embodiments of the present invention and the accompanying drawings.

### First Example Embodiment

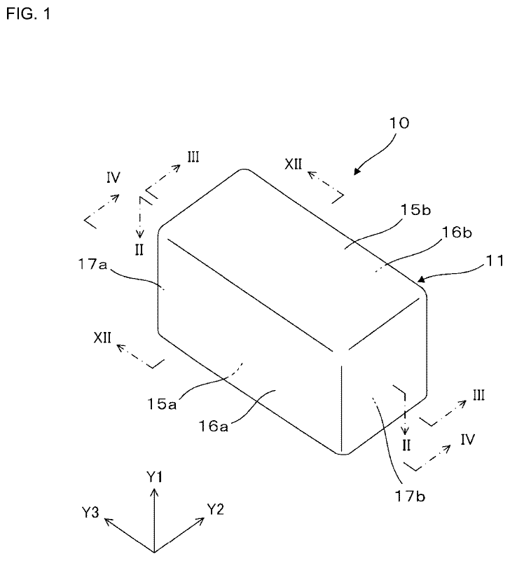

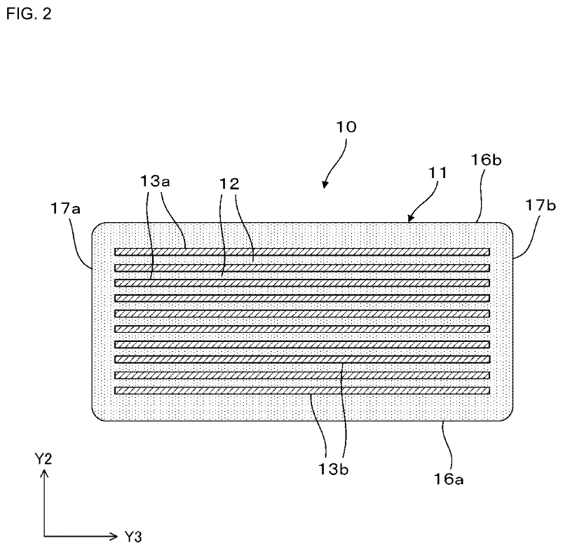

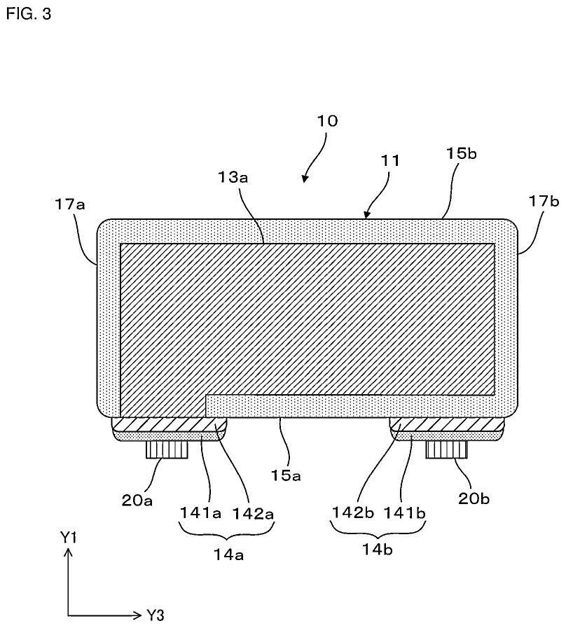

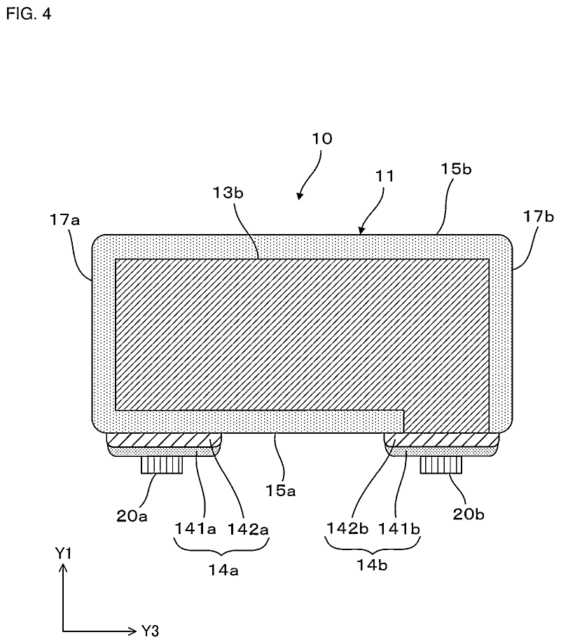

FIG. 1 is a perspective view schematically illustrating a multilayer ceramic capacitor 10 according to a first example embodiment of the present invention. FIG. 2 is a sectional view schematically illustrating a structure when the multilayer ceramic capacitor 10 illustrated in FIG. 1 is sectioned along the II-II line. FIG. 3 is a sectional view schematically illustrating a structure when the multilayer ceramic capacitor 10 illustrated in FIG. 1 is sectioned along the III-III line. FIG. 4 is a sectional view schematically illustrating a structure when the multilayer ceramic capacitor 10 illustrated in FIG. 1 is sectioned along the IV-IV line. FIG. 3 is the sectional view at a position where a first inner electrode 13a is provided, and FIG. 4 is the sectional view at a position where a second inner electrode 13b is provided.

The multilayer ceramic capacitor 10 includes a capacitor body 11, a first outer electrode 14a provided to a surface of the capacitor body 11, a second outer electrode 14b provided to the surface of the capacitor body 11, a first bump 20a provided to a surface of the first outer electrode 14a, and a second bump 20b provided to a surface of the second outer electrode 14b.

The capacitor body 11 includes a laminate of multiple dielectric layers 12, multiple first inner electrodes 13a, and multiple second inner electrodes 13b. Here, a direction in which the dielectric layers 12, the first inner electrodes 13a, and the second inner electrodes 13b are laminated will be referred to as a direction of lamination. The capacitor body 11 is configured such that the multiple first inner electrodes 13a and the multiple second inner electrodes 13b are laminated on one another in the direction of lamination with the dielectric layers 12 interposed therebetween.

The capacitor body 11 has a rectangular or substantially rectangular parallelepiped shape. Corner portions and ridge portions of the capacitor body 11 of the present example embodiment are rounded. A corner portion is a portion where three surfaces of the capacitor body 11 intersect with one another while a ridge portion is a portion where two surfaces of the capacitor body 11 intersect with each other. That is to say, the capacitor body 11 does not have a perfect rectangular parallelepiped shape due to the corner portions and the rounded ridge portions which are rounded. However, the capacitor body 11 has such a shape that is provided with six outer surfaces and can be regarded as the rectangular or substantially rectangular parallelepiped as a whole.

The capacitor body 11 includes a first principal surface 15a and a second principal surface 15b which are opposed to each other in a first direction Y1, a first side surface 16a and a second side surface 16b which are opposed to each other in a second direction Y2 orthogonal or substantially orthogonal to the first direction Y1, and a first end surface 17a and a second end surface 17b which are opposed to each other in a third direction Y3 orthogonal or substantially orthogonal to the first direction Y1 and the second direction Y2. The first principal surface 15a is one of the surfaces of the capacitor body 11, which is the surface on the side provided with the first bump 20a and the second bump 20b to be described later. Two arbitrary directions of the first direction Y1, the second direction Y2, and the third direction Y3 are the directions orthogonal or substantially orthogonal to each other.

In the present example embodiment, the direction of lamination is equivalent to the second direction Y2 as illustrated in FIG. 2. That is to say, the multiple dielectric layers 12, the multiple first inner electrodes 13a, and the multiple second inner electrodes 13b are laminated in the direction of opposition of the first side surface 16a to the second side surface 16b.

The multilayer ceramic capacitor 10 according to the present example embodiment has a structure suitable to be mounted by ultrasonic joining. To this end, a Young's modulus of the capacitor body 11 is preferably equal to or greater than about 67 GPa, for example. By setting the Young's modulus of the capacitor body 11 equal to or greater than about 67 GPa, ultrasonic vibration applied to the multilayer ceramic capacitor 10 is transmitted more effectively to the first bump 20a and the second bump 20b to be described later.

The dielectric layers 12 are made of a ceramic material that includes any of BaTiO₃, CaTiO₃, SrTiO₃, SrZrO₃, CaZrO₃, and the like as a major component, for example. An accessory component such as, for example, a Mn compound, a Fe compound, a Cr compound, a Co compound, or a Ni compound in a smaller content than that of the major component may be added to any of these major components.

The first inner electrodes 13a and the second inner electrodes 13b include, for example, Ni, Ag, Pd, Au, Cu, Ti, or Cr, or an alloy including any of the aforementioned metals as a major component, and the like. The first inner electrodes 13a and the second inner electrodes 13b may include, for example, the same ceramic material as the dielectric ceramic contained in the dielectric layers 12 as a common material. A content percentage of the common material in the first inner electrodes 13a is, for example, about 20% by volume or less of the entire first inner electrodes 13a. The same applies to content percentage of the common material in the second inner electrodes 13b.

As illustrated in FIG. 3, the first inner electrode 13a is extracted to the first principal surface 15a of the capacitor body 11 on the first end surface 17a side in the third direction Y3, and is electrically coupled to the first outer electrode 14a to be described later.

As illustrated in FIG. 4, the second inner electrode 13b is extracted to the first principal surface 15a of the capacitor body 11 on the second end surface 17b side in the third direction Y3, and is electrically coupled to the second outer electrode 14b to be described later.

Here, besides the first inner electrodes 13a and the second inner electrode 13b, the capacitor body 11 may include inner electrodes that are not electrically coupled to the first outer electrode 14a and the second outer electrode 14b. Meanwhile, all of the multiple first inner electrodes 13a provided therein do not always have to include the same material and materials may be partially different. Moreover, the material may be partially different in each first inner electrode 13a. The same applies to the second inner electrodes 13b.

An electrostatic capacitance is generated by opposing the first inner electrodes 13a to the second inner electrodes 13b with the dielectric layers 12 interposed therebetween. Thus, these elements define and function as a capacitor.

The first outer electrode 14a is provided on at least the first principal surface 15a of the surfaces of the capacitor body 11, and is electrically coupled to the first inner electrodes 13a. In the present example embodiment, the first outer electrode 14a is provided only on the first principal surface 15a of the surfaces of the capacitor body 11 as illustrated in FIGS. 1 to 4. The first outer electrode 14a covers the multiple first inner electrodes 13a extracted to the first principal surface 15a of the capacitor body 11, and is spaced away from the second outer electrode 14b.

The second outer electrode 14b is provided on at least the first principal surface 15a of the surfaces of the capacitor body 11, and is electrically coupled to the second inner electrodes 13b. In the present example embodiment, the second outer electrode 14b is provided only on the first principal surface 15a out of the surfaces of the capacitor body 11 as illustrated in FIGS. 1 to 4. The second outer electrode 14b covers the multiple second inner electrodes 13b extracted to the first principal surface 15a of the capacitor body 11, and is spaced away from the first outer electrode 14a.

The first outer electrode 14a includes a first metal layer 141a which is provided on at least a position that comes into contact with the first bump 20a to be described later, and is made of the same material as that of the first bump 20a. In the present example embodiment, the first outer electrode 14a includes a first foundation electrode layer 142a and the first metal layer 141a disposed on the first foundation electrode layer 142a.

The first foundation electrode layer 142a includes at least one layer of a baked electrode layer, a resin electrode layer, a thin film electrode layer, and the like to be described below, for example.

The baked electrode layer is a layer including glass and a metal, which may include one layer or two or more layers. The baked electrode layer includes, for example, a metal such as Cu, Ni, Ag, Pd, Ti, Cr, or Au, or an alloy including any of these metals, or the like.

The baked electrode layer is formed by applying and baking a conductive paste including the glass and the metal onto the capacitor body 11. The baking may be performed simultaneously with firing of an unfired capacitor body or performed after fabricating the capacitor body 11 by firing.

The resin electrode layer can be a layer including conductive particles and a thermosetting resin, for example. In the case of forming the resin electrode layer, the resin electrode layer may be directly formed on the capacitor body 11 without forming the baked electrode layer. The resin electrode layer may include one layer or two or more layers.

The thin film electrode layer is, for example, a layer equal to or less than about 1 μm prepared by depositing metal particles, which can be formed in accordance with a publicly known thin film forming method such as, for example, a sputtering method and a vapor deposition method.

The first metal layer 141a is formed by plating, for example. A thickness of the first metal layer 141a is preferably equal to or greater than about 0.3 μm, for example. The ultrasonic joining can be conducted more reliably by setting the thickness of the first metal layer 141a equal to or greater than about 0.3 μm.

Nevertheless, the configuration of the first outer electrode 14a is not limited to the above-described configuration. For example, the first outer electrode 14a may include the first metal layer 141a alone. Meanwhile, in the case where the first metal layer 141a is the plated layer, another plated layer made of a different metal such as, for example, a Ni plated layer may be provided between the first foundation electrode layer 142a and the first metal layer 141a.

The second outer electrode 14b includes a second metal layer 141b which is provided on at least a position that comes into contact with the second bump 20b to be described later, and is made of the same material as that of the second bump 20b. In the present example embodiment, the second outer electrode 14b includes a second foundation electrode layer 142b and the second metal layer 141b disposed on the second foundation electrode layer 142b.

The second foundation electrode layer 142b includes at least one layer out of the baked electrode layer, the resin electrode layer, the thin film electrode layer, and the like as described above, for example.

The second metal layer 141b is formed by plating, for example. A thickness of the second metal layer 141b is preferably equal to or greater than about 0.3 μm, for example. The ultrasonic joining can be conducted more reliably by setting the thickness of the second metal layer 141b equal to or greater than about 0.3 μm, for example.

Nevertheless, the configuration of the second outer electrode 14b is not limited to the above-described configuration. For example, the second outer electrode 14b may include the second metal layer 141b alone. Meanwhile, in the case where the second metal layer 141b is the plated layer, another plated layer made of a different metal such as, for example, a Ni plated layer may be provided between the second foundation electrode layer 142b and the second metal layer 141b.

The first outer electrode 14a and the second outer electrode 14b are not provided on the second principal surface 15b of the capacitor body 11. In the present example embodiment, the first outer electrode 14a and the second outer electrode 14b is avoided not only on the second principal surface 15b of the capacitor body 11 but also on the first side surface 16a, the second side surface 16b, the first end surface 17a, and the second end surface 17b.

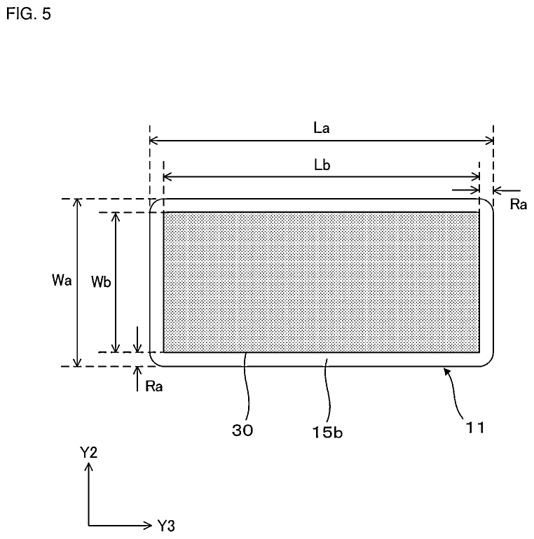

The first principal surface 15a, the second principal surface 15b, the first side surface 16a, the second side surface 16b, the first end surface 17a, and the second end surface 17b of the capacitor body 11 are flat or substantially flat. The respective surfaces of the capacitor body 11 are not completely flat since the corner portions and the ridge portions are rounded as described above. Nonetheless, a proportion of an area of a flat region of the second principal surface 15b of the capacitor body 11 relative to an area of the second principal surface 15b thereof is, for example, preferably equal to or greater than about 0.8. This will be described with reference to FIG. 5.

As illustrated in FIG. 5, of the second principal surface 15b of the capacitor body 11, a dimension in the third direction Y3 will be defined as La, a dimension in the second direction Y2 will be defined as Wa, a dimension in the third direction Y3 of a flat region 30 excluding the rounded portions will be defined as Lb, and a dimension in the second direction Y2 thereof will be defined as Wb. In the meantime, a curvature radius at the corner portion will be defined as Ra. The dimensions La and Lb in the third direction Y3 satisfy a relation defined by the following formula (1) while the dimensions Wa and Wb in the second direction Y2 satisfy a relation defined by the following formula (2):

$$Lb = L a - 2 Ra ; and \qquad ( 1 )$$

$$Wb = Wa - 2 Ra . \qquad ( 2 )$$

Specifically, the flat region 30 of the second principal surface 15b of the capacitor body 11 is a region of the second principal surface 15b excluding rounded regions located on both sides in the third direction Y3 and rounded regions located on both sides in the second direction Y2. Here, an area Sa of the second principal surface 15b of the capacitor body 11 will be defined as La×Wa as expressed in the following formula (3). Meanwhile, an area Sb of the flat region 30 of the second principal surface 15b will be defined as Lb×Wb as expressed in the following formula (4):

$$Sa = La \times Wa ; and \qquad ( 3 )$$

$$Sb = Lb \times Wb . \qquad ( 4 )$$

Accordingly, a proportion K1 of the area Sb of the flat region 30 of the second principal surface 15b relative to the area Sa of the second principal surface 15b of the capacitor body 11 will be expressed by the following formula (5):

$$K 1 = ( La - 2 Ra ) \times ( Wa - 2 Ra ) / ( La \times Wa ) . \qquad ( 5 )$$

In other words, the proportion K1 of the area Sb of the flat region 30 of the second principal surface 15b relative to the area Sa of the second principal surface 15b of the capacitor body 11 expressed by the formula (5) is, for example, preferably equal to or greater than about 0.8. By setting the proportion K1 of the area Sb of the flat region 30 of the second principal surface 15b relative to the area Sa of the second principal surface 15b equal to or greater than about 0.8, it is possible to ensure a sufficiently large area of contact between the second principal surface 15b of the capacitor body 11 and a holding surface of a holder when performing the ultrasonic joining as will be described later, and to reduce or prevent the occurrence of cracks more effectively.

As illustrated in FIGS. 3 and 4, the first bump 20a is provided on the surface on the first principal surface 15a side of the capacitor body 11 of the surfaces of the first outer electrode 14a. Meanwhile, the second bump 20b is provided on the surface on the first principal surface 15a side of the capacitor body 11 of the surfaces of the second outer electrode 14b.

The first bump 20a is made of, for example, one of Au, Cu, or Al which are suitable for solid phase joining. The second bump 20b is made of the same material as that of the first bump 20a, for example. Meanwhile, as described above, the first metal layer 141a of the first outer electrode 14a is made of the same material as that of the first bump 20a, and the second metal layer 141b of the second outer electrode 14b is made of the same material as that of the second bump 20b, for example. In other words, all of the first bump 20a, the second bump 20b, the first metal layer 141a, and the second metal layer 141b are made of the same material, for example.

Thicknesses in the first direction Y1 of the first bump 20a and the second bump 20b are, for example, equal to or greater than 4.5 μm. As a consequence of fabricating multiple multilayer ceramic capacitors having different thicknesses of the first bump 20a and the second bump 20b and subjecting the multilayer ceramic capacitors to the ultrasonic joining, the inventors of example embodiments of the present invention have confirmed that the joining is feasible when the thicknesses are at least equal to or greater than about 4.5 μm, for example.

The first bump 20a and the second bump 20b can be formed in accordance with an arbitrary method such as, for example, a screen printing method and a dispensing method.

### Manufacturing Method

An example of a manufacturing method of the above-described multilayer ceramic capacitor 10 will be described below. First, a ceramic green sheet and a conductive paste for inner electrodes are prepared, respectively. Each of the ceramic green sheet and the conductive paste for inner electrodes can use a publicly known material including organic binder and an organic solvent.

Next, an inner electrode pattern is formed by applying the conductive paste for inner electrodes onto the ceramic green sheet. The application of the conductive paste for inner electrodes can use a printing method such as screen printing and gravure printing, for example.

Subsequently, a predetermined number of ceramic green sheets not provided with inner electrode patterns are laminated, then the ceramic green sheet provided with the inner electrode pattern is laminated sequentially thereon, and a then predetermined number of ceramic green sheets not provided with inner electrode patterns are laminated thereon, thus fabricating a mother multilayer body.

Next, the mother multilayer body is pressed in the direction of lamination in accordance with a method such as, for example, rigid body pressing and isostatic pressing, and is then cut into a predetermined size in accordance with a cutting method such as, for example, pressure cutting, cutting with a dicing machine, and laser cutting. Thereafter, the corner portions and the ridge portions are rounded by, for example, barrel polishing and the like, and then the capacitor body 11 is obtained by baking at a predetermined profile.

Subsequently, the first foundation electrode layer 142a and the second foundation electrode layer 142b are formed by applying and baking a conductive paste for outer electrodes onto at least the first principal surface 15a out of the surfaces of the capacitor body 11. The conductive paste for outer electrodes can use a publicly known material.

Next, the first metal layer 141a and the second metal layer 141b are formed by performing plating processing on the first foundation electrode layer 142a and the second foundation electrode layer 142b.

Lastly, the first bump 20a is formed at a position to come into contact with the first metal layer 141a and the second bump 20b is formed at a position to come into contact with the second metal layer 141b. As described above, the first bump 20a and the second bump 20b can be formed in accordance with a method such as, for example, the screen printing method and a dispensing method.

The multilayer ceramic capacitor 10 can be manufactured by the above-described process. However, the manufacturing method of the multilayer ceramic capacitor 10 is not limited to the aforementioned manufacturing method, and the multilayer ceramic capacitor 10 can be manufactured in accordance with a different manufacturing method.

### Mounting Method

An example of a method of mounting the multilayer ceramic capacitor 10 according to the present example embodiment by the ultrasonic joining will be described below.

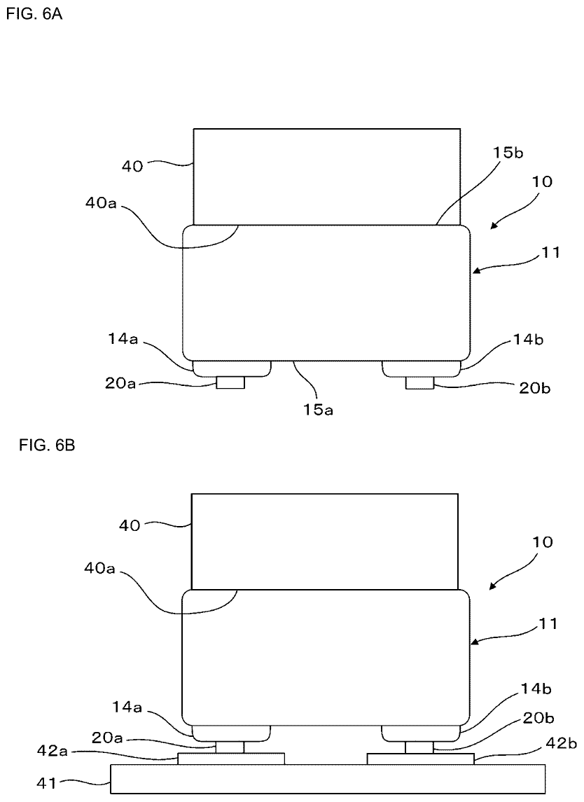

First, as illustrated in FIG. 6A, the multilayer ceramic capacitor 10 is held with a holder 40 including a flat holding surface 40a. To be more precise, the holder 40 holds the multilayer ceramic capacitor 10 in a state where the holding surface 40a is in contact with the second principal surface 15b of the capacitor body 11. As described above, the second principal surface 15b of the capacitor body 11 is not provided with the first outer electrode 14a and the second outer electrode 14b.

The holder 40 may be of any type as long as the holder 40 can hold the multilayer ceramic capacitor 10 in the state where the holding surface 40a is in contact with the second principal surface 15b of the capacitor body 11. For example, the holder 40 is a collet that suctions and holds the multilayer ceramic capacitor 10 onto the holding surface 40a by suctioning.

Next, as illustrated in FIG. 6B, the multilayer ceramic capacitor 10 held with the holder 40 is brought into contact with land electrodes 42a and 42b provided to a substrate 41. To be more precise, the first bump 20a is brought into contact with the first land electrode 42a and the second bump 20b is brought into contact with the second land electrode 42b.

Subsequently, ultrasonic vibration is applied to the holder 40 while pressing the multilayer ceramic capacitor 10 against the land electrodes 42a and 42b by using the holder 40. The multilayer ceramic capacitor 10 may be heated at the time of application of the ultrasonic vibration. The ultrasonic vibration to be applied is vibration in a direction parallel or substantially parallel to the principal surfaces 15a and 15b of the capacitor body 11. In the case where the substrate 41 is location on a horizontal plane, the direction parallel or substantially parallel to the principal surfaces 15a and 15b of the capacitor body 11 is a horizontal direction. In this way, the first bump 20a is crushed and the first metal layer 141a of the first outer electrode 14a is joined to the first land electrode 42a by the intermediary of the first bump 20a. Meanwhile, the second bump 20b is crushed and the second metal layer 141b of the second outer electrode 14b is joined to the second land electrode 42b by the intermediary of the second bump 20b.

As described above, according to the multilayer ceramic capacitor 10 of the present example embodiment, the second principal surface 15b of the capacitor body 11 to come into contact with the holding surface 40a of the holder 40 is not provided with the first outer electrode 14a and the second outer electrode 14b. Therefore, the flat surfaces come into contact with each other between the holding surface 40a of the holder 40 and the second principal surface 15b of the capacitor body 11. For this reason, the multilayer ceramic capacitor 10 is vibrated in a direction parallel or substantially parallel to the principal surfaces 15a and 15b of the capacitor body 11 by applying the ultrasonic vibration to the holder 40 in the state where the holding surface 40a of the holder 40 is in contact with the second principal surface 15b of the capacitor body 11. Accordingly, the stress concentration on the first side surface 16a, the second side surface 16b, the first end surface 17a, and the second end surface 17b of the capacitor body 11 is relaxed when the ultrasonic vibration is applied. Thus, the occurrence of cracks can be reduced or prevented.

Meanwhile, since the second principal surface 15b of the capacitor body 11 to come into contact with the holding surface 40a of the holder 40 is not provided with the first outer electrode 14a and the second outer electrode 14b, a contact area between the holding surface 40a and the capacitor body 11 is larger as compared to the configuration provided with the outer electrodes. Accordingly, an impact load to be applied to the second principal surface 15b of the capacitor body 11, which comes into contact with the holding surface 40a, is relaxed at the time of application of the ultrasonic vibration, so that the occurrence of cracks can be reduced or prevented.

In particular, by providing the configuration in which the proportion K1 of the area Sb of the flat region 30 of the second principal surface 15b relative to the area Sa of the second principal surface 15b of the capacitor body 11 is equal to or greater than about 0.8, for example, it is possible to further increase the contact area between the holding surface 40a of the holder 40 and the capacitor body 11, so that the occurrence of cracks can further be reduced or prevented.

As described above, since the multilayer ceramic capacitor 10 according to the present example embodiment is suitable for mounting by the ultrasonic joining, it is possible to perform mounting by the ultrasonic joining at a mounting location where there is a concern of an influence by flux residue at the time of joining by using solder, for example.

Here, aspects of vibration and stress distribution in the case of performing the ultrasonic joining by applying the ultrasonic vibration were investigated by simulation using the multilayer ceramic capacitor of the present example embodiment in which the first outer electrode 14a and the second outer electrode 14b are provided only on the first principal surface 15a of the capacitor body 11 and a multilayer ceramic capacitor of a comparative example in which the outer electrodes are provided on all of surfaces of a capacitor body. In the multilayer ceramic capacitor of the comparative example, the outer electrodes are provided on the entirety of a pair of end surfaces of the capacitor body and extend from the pair of end surfaces and wrap around a pair of principal surfaces and a pair of side surfaces, respectively.

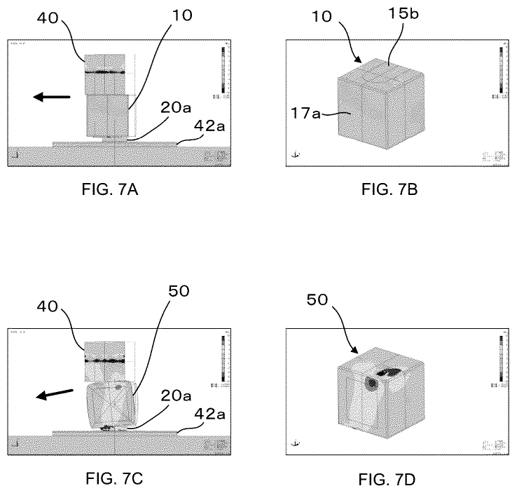

FIG. 7A is a perspective view illustrating a simulation result showing a direction of displacement and stress distribution of the multilayer ceramic capacitor 10 according to the present example embodiment when the ultrasonic vibration is applied thereto, and FIG. 7B is a diagram illustrating the simulation result of the stress distribution of the multilayer ceramic capacitor 10 according to the present example embodiment. FIG. 7C is a diagram illustrating a simulation result depicting a direction of displacement and stress distribution of a multilayer ceramic capacitor 50 according to a comparative example when the ultrasonic vibration is applied thereto, and FIG. 7D is a perspective view illustrating the simulation result of the stress distribution of the multilayer ceramic capacitor 50 according to the comparative example. Here, FIGS. 7A and 7C are diagrams viewed from the end surface side of the capacitor body.

FIGS. 7B and 7D illustrate only a half of the multilayer ceramic capacitor sectioned at a position at the center or approximate center in the third direction Y3. In FIGS. 7A to 7D, the stress distribution is shown in grayscale. A portion with a thick color such as black is a region on which the stress is concentrated.

When the ultrasonic vibration is applied, the multilayer ceramic capacitor 10 of the present example embodiment is displaced in the horizontal direction as illustrated in FIG. 7A. On the other hand, the multilayer ceramic capacitor 50 of the comparative example is displaced obliquely downward as illustrated in FIG. 7C. In other words, the multilayer ceramic capacitor 50 of the comparative example is displaced obliquely downward instead of the horizontal direction when the ultrasonic vibration is applied thereto, because the outer electrodes provided in partial regions on the second principal surface of the capacitor body come into contact with the holding surface 40a of the holder 40 and the ridge portions of the outer electrodes that come into contact with the holding surface 40a are rounded.

In the meantime, as illustrated in FIG. 7B, there is a very small portion in the multilayer ceramic capacitor 10 of the present example embodiment on which the stress is locally concentrated when the ultrasonic vibration is applied thereto. Accordingly, the occurrence of cracks is reduced or prevented when carrying out the ultrasonic joining.

On the other hand, in the multilayer ceramic capacitor 50 of the comparative example, there are regions on the end surface, the principal surface, and the side surface on which the stress is locally concentrated as illustrated in FIG. 7D. Accordingly, there is a possibility of the occurrence of cracks attributed to the stress concentration when performing the ultrasonic joining.

The presence or absence of the occurrence of cracks when performing the ultrasonic joining has been investigated by using the multilayer ceramic capacitor 10 of the present example embodiment and the multilayer ceramic capacitor 50 of the above-described comparative example. Here, multiple samples of the multilayer ceramic capacitor 10 of the present example embodiment and the multilayer ceramic capacitor 50 of the comparative example were prepared, respectively, and the presence or absence of the occurrence of cracks was investigated while changing amplitude of the ultrasonic vibration. A vibration period of the applied ultrasonic vibration was set equal to about 0.5 second, and a load to be applied to the multilayer ceramic capacitors at the time of application of the ultrasonic vibration was set equal to about 5 N. Regarding the number of occurrence of cracks, the number of occurrence in three samples was indicated in the case of the multilayer ceramic capacitor 10 of the present example embodiment, while the number of occurrence in five samples was indicated in the case of the multilayer ceramic capacitor 50 of the comparative example. A result of investigation is depicted in Table 1.

TABLE 1

| | NUMBER OF | NUMBER OF |
|---|---|---|
| | OCCURRENCE OF | OCCURRENCE OF |
| | CRACKS IN | CRACKS IN |
| | MULTILAYER | MULTILAYER |
| | CERAMIC | CERAMIC |
| | CAPACITOR OF | CAPACITOR OF |
| AMPLITUDE | PRESENT | COMPARATIVE |
| (μm) | INVENTION | EXAMPLE |
| 0.25 | 0/3 | 5/5 |
| 0.50 | 0/3 | 5/5 |
| 0.75 | 0/3 | 5/5 |

As shown in Table 1, in every case of setting the amplitude of the ultrasonic vibration equal to about 0.25 μm, about 0.50 μm, and about 0.75 μm, no cracks occurred in all of the samples of the multilayer ceramic capacitor 10 of the present example embodiment. In contrast, in every case of setting the amplitude of the ultrasonic vibration equal to about 0.25 μm, about 0.50 μm, and about 0.75 μm, cracks occurred in all of the five samples of the multilayer ceramic capacitor 50 of the comparative example.

### Second Example Embodiment

In a multilayer ceramic capacitor 10A according to a second example embodiment of the present invention, the first outer electrode 14a and the second outer electrode 14b are provided on at least the first principal surface 15a of the surfaces of the capacitor body 11 and are not provided on the second principal surface 15b opposed to the first principal surface 15a as with the multilayer ceramic capacitor 10 according to the first example embodiment. However, in the multilayer ceramic capacitor 10A according to the second example embodiment, the first outer electrode 14a and the second outer electrode 14b are provided on a wider surface of the capacitor body 11 as compared to the multilayer ceramic capacitor 10 according to the first example embodiment.

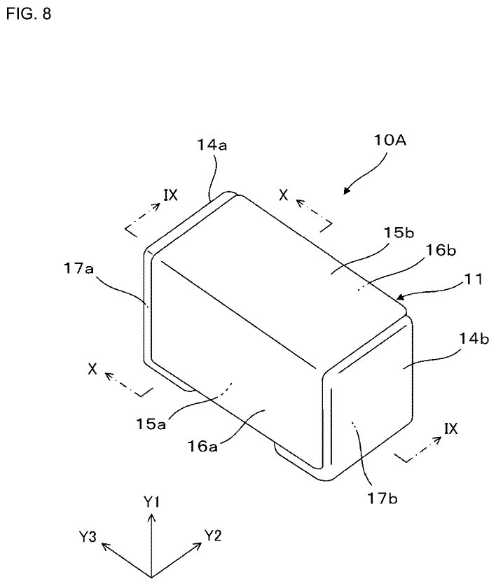

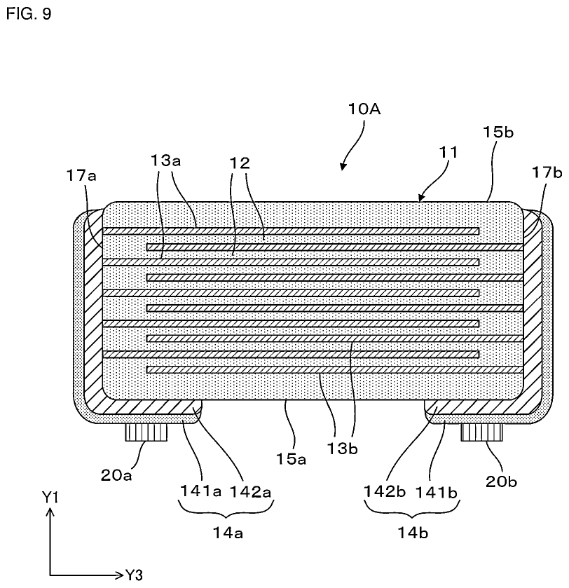

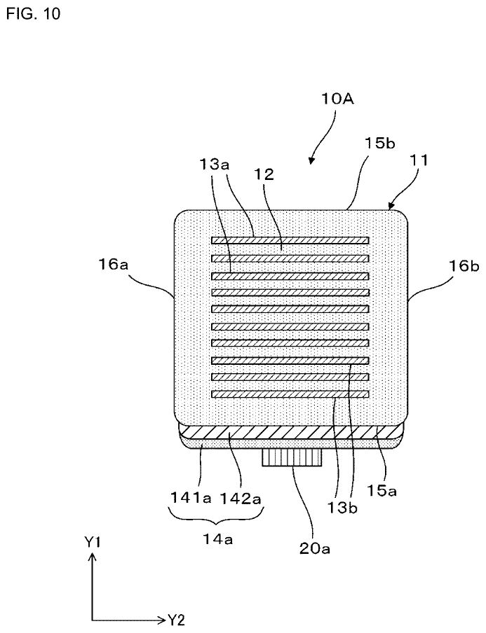

FIG. 8 is a perspective view schematically illustrating the multilayer ceramic capacitor 10A according to the second example embodiment. FIG. 9 is a sectional view schematically illustrating a structure when the multilayer ceramic capacitor 10A illustrated in FIG. 8 is sectioned along the IX-IX line. FIG. 10 is a sectional view schematically illustrating a structure when the multilayer ceramic capacitor 10A illustrated in FIG. 8 is sectioned along the X-X line.

In the present example embodiment, the direction of lamination is equivalent to the first direction Y1 as illustrated in FIGS. 9 and 10. That is to say, the multiple dielectric layers 12, the multiple first inner electrodes 13a, and the multiple second inner electrodes 13b are laminated in the direction of opposition of the first principal surface 15a and the second principal surface 15b.

As illustrated in FIG. 9, the first inner electrodes 13a are extracted to the first end surface 17a of the capacitor body 11, and are electrically coupled to the first outer electrode 14a. The first inner electrodes 13a are not extracted to the second end surface 17b of the capacitor body 11.

As illustrated in FIG. 9, the second inner electrodes 13b are extracted to the second end surface 17b of the capacitor body 11, and are electrically coupled to the second outer electrode 14b. The second inner electrodes 13b are not extracted to the first end surface 17a of the capacitor body 11.

As described above, the first outer electrode 14a is provided on at least the first principal surface 15a of the surfaces of the capacitor body 11. In the present example embodiment, the first outer electrode 14a is provided on the first principal surface 15a and on the first end surface 17a of the surfaces of the capacitor body 11 as illustrated in FIGS. 8 to 10. The first outer electrode 14a may be provided to the entirety or a portion of the first end surface 17a as long as the first outer electrode 14a is provided to cover the multiple first inner electrodes 13a extracted to the first end surface 17a of the capacitor body 11.

As described above, the second outer electrode 14b is provided on at least the first principal surface 15a of the surfaces of the capacitor body 11. In the present example embodiment, the second outer electrode 14b is provided on the first principal surface 15a and the second end surface 17b of the surfaces of the capacitor body 11 as illustrated in FIGS. 8 to 10. The second outer electrode 14b may be provided on the entirety or a portion of the second end surface 17b as long as the second outer electrode 14b is provided to cover the multiple second inner electrodes 13b extracted to the second end surface 17b of the capacitor body 11.

The first outer electrode 14a and the second outer electrode 14b are not provided on the second principal surface 15b of the capacitor body 11 in the multilayer ceramic capacitor 10A according to the present example embodiment. The multilayer ceramic capacitor 10A according to the second example embodiment can therefore reduce or prevent the occurrence of cracks when performing the ultrasonic joining as with the multilayer ceramic capacitor 10 according to the first example embodiment. Although the structure of the capacitor body 11 is different, the multilayer ceramic capacitor 10A according to the second example embodiment can be manufactured in accordance with the same or substantially the same manufacturing method used for the multilayer ceramic capacitor 10 according to the first example embodiment.

### Third Example Embodiment

In a multilayer ceramic capacitor 10B according to a third example embodiment of the present invention, the first outer electrode 14a and the second outer electrode 14b are provided on at least the first principal surface 15a of the surfaces of the capacitor body 11 and are not provided to the second principal surface 15b opposed to the first principal surface 15a as with the multilayer ceramic capacitor 10 according to the first example embodiment. However, in the multilayer ceramic capacitor 10B according to the third example embodiment, the first outer electrode 14a and the second outer electrode 14b are provided on a wider surface of the capacitor body 11 as compared to the multilayer ceramic capacitor 10 according to the first example embodiment and the multilayer ceramic capacitor 10A according to the second example embodiment.

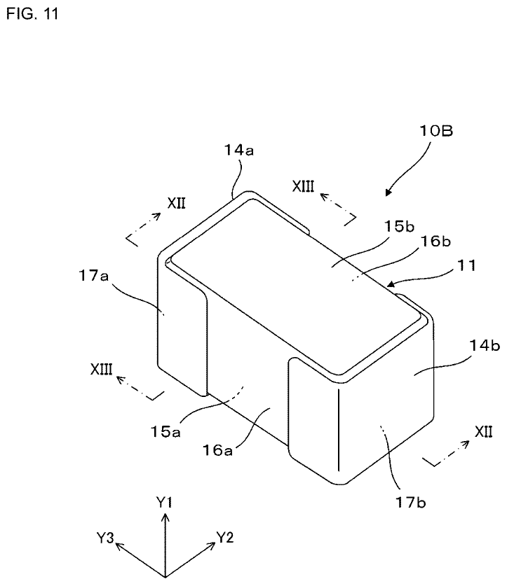

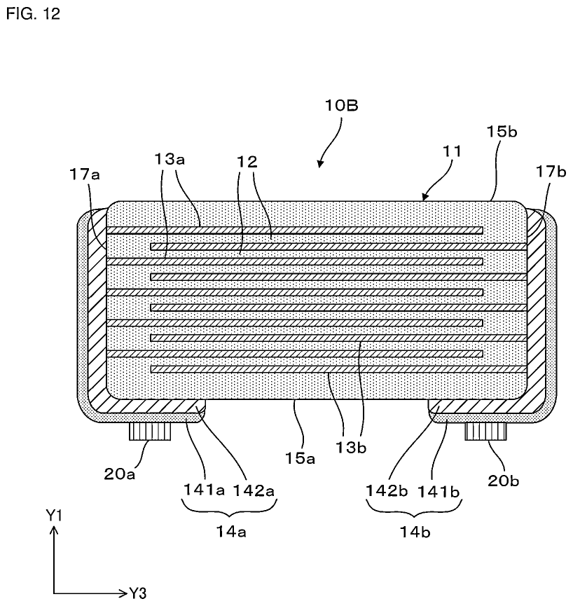

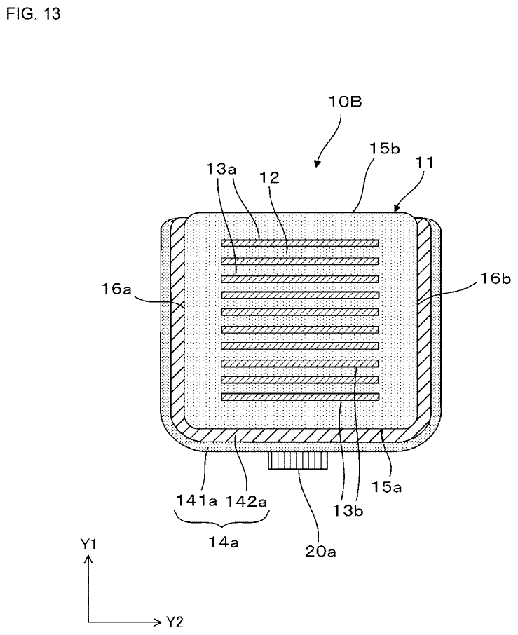

FIG. 11 is a perspective view schematically illustrating the multilayer ceramic capacitor 10B according to the third example embodiment. FIG. 12 is a sectional view schematically illustrating a structure when the multilayer ceramic capacitor 10B illustrated in FIG. 11 is sectioned along the XII-XII line. FIG. 13 is a sectional view schematically illustrating a structure when the multilayer ceramic capacitor 10B illustrated in FIG. 10 is sectioned along the XIII-XIII line.

In the present example embodiment, the direction of lamination is the same or substantially the same as the first direction Y1 as illustrated in FIGS. 12 and 13 as with the second example embodiment. That is to say, the multiple dielectric layers 12, the multiple first inner electrodes 13a, and the multiple second inner electrodes 13b are laminated in the direction of opposition of the first principal surface 15a and the second principal surface 15b.

As described above, the first outer electrode 14a is provided on at least the first principal surface 15a of the surfaces of the capacitor body 11. In the present example embodiment, the first outer electrode 14a is provided on the first principal surface 15a, the first end surface 17a, the first side surface 16a, and the second side surface 16b of the surfaces of the capacitor body 11 as illustrated in FIGS. 11 to 13.

As described above, the second outer electrode 14b is provided on at least the first principal surface 15a of the surfaces of the capacitor body 11. In the present example embodiment, the second outer electrode 14b is provided on the first principal surface 15a, the second end surface 17b, the first side surface 16a, and the second side surface 16b of the surfaces of the capacitor body 11 as illustrated in FIGS. 11 to 13.

The first outer electrode 14a and the second outer electrode 14b are not provided on the second principal surface 15b of the capacitor body 11 in the multilayer ceramic capacitor 10B according to the present example embodiment. The multilayer ceramic capacitor 10B according to the third example embodiment can therefore reduce or prevent the occurrence of cracks when performing the ultrasonic joining as with the multilayer ceramic capacitor 10 according to the first example embodiment.

Note that although the structure of the capacitor body 11 is different, the multilayer ceramic capacitor 10B according to the third example embodiment can be manufactured in accordance with the same or substantially the same manufacturing method used for the multilayer ceramic capacitor 10 according to the first example embodiment.

### Fourth Example Embodiment

In a multilayer ceramic capacitor 10C according to a fourth example embodiment of the present invention, the first outer electrode 14a and the second outer electrode 14b are provided on at least the first principal surface 15a of the surfaces of the capacitor body 11 and are not provided on the second principal surface 15b opposed to the first principal surface 15a as with the multilayer ceramic capacitor 10 according to the first example embodiment. Although the multilayer ceramic capacitor 10C according to the fourth example embodiment has the same or substantially the same external shape as that of the multilayer ceramic capacitor 10 according to the first example embodiment, the multilayer ceramic capacitor 10C has a different structure of the capacitor body 11.

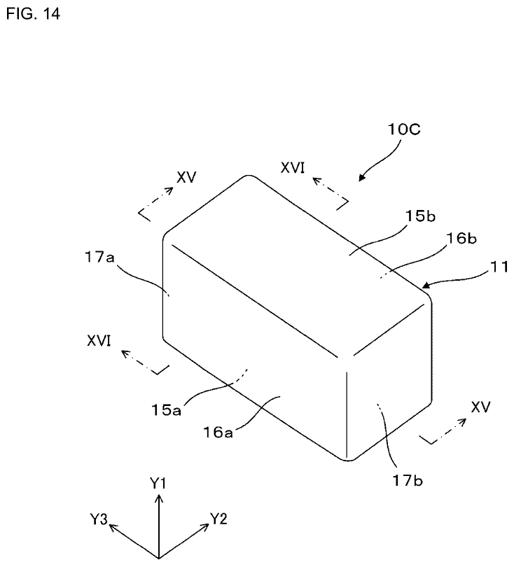

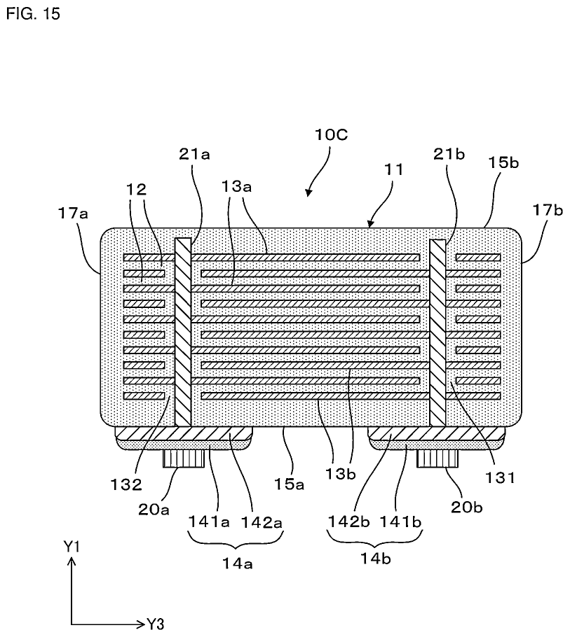

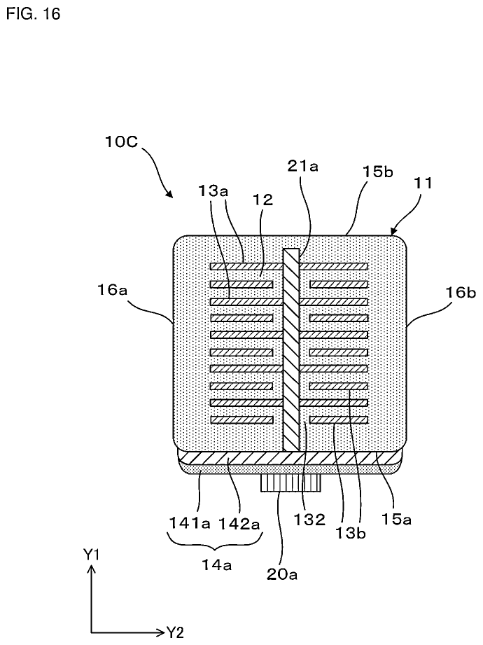

FIG. 14 is a perspective view schematically illustrating the multilayer ceramic capacitor 10C according to the fourth example embodiment. FIG. 15 is a sectional view schematically illustrating a structure when the multilayer ceramic capacitor 10C illustrated in FIG. 14 is sectioned along the XV-XV line. FIG. 16 is a sectional view schematically illustrating a structure when the multilayer ceramic capacitor 10C illustrated in FIG. 14 is sectioned along the XVI-XVI line.

In the present example embodiment, the direction of lamination is also equivalent to the first direction Y1 as illustrated in FIGS. 15 and 16 as with the second and third example embodiments. That is to say, the multiple dielectric layers 12, the multiple first inner electrodes 13a, and the multiple second inner electrodes 13b are laminated in the direction of opposition of the first principal surface 15a and the second principal surface 15b.

As with the multilayer ceramic capacitor 10 according to the first example embodiment, the first outer electrode 14a is provided only on the first principal surface 15a of the surfaces of the capacitor body 11 as illustrated in FIGS. 14 to 16. Meanwhile, the second outer electrode 14b is provided only on the first principal surface 15a of the surfaces of the capacitor body 11.

Unlike the multilayer ceramic capacitors 10 to 10B according to the respective example embodiments described above, in the multilayer ceramic capacitor 10C according to the present example embodiment, the first inner electrodes 13a and the second inner electrodes 13b are not extended to any surfaces of the capacitor body 11. A first via conductor 21a to electrically couple the multiple first inner electrodes 13a to the first outer electrode 14a, and a second via conductor 21b to electrically couple the multiple second inner electrodes 13b to the second outer electrode 14b are provided inside the capacitor body 11.

Each first inner electrode 13a includes a first through hole 131 to allow penetration of the second via conductor 21b, and each second inner electrode 13b includes a second through hole 132 to allow penetration of the first via conductor 21a.

The first via conductor 21a is provided inside the capacitor body 11 to extend in the first direction Y1, and is electrically coupled to the multiple first inner electrodes 13a. The first via conductor 21a penetrates the second through holes 132 provided to the second inner electrodes 13b, and is insulated from the second inner electrodes 13b.

The first via conductor 21a is exposed to at least the first principal surface 15a of the capacitor body 11. Although FIGS. 15 and 16 illustrate a configuration in which the first via conductor 21a is not exposed to the second principal surface 15b of the capacitor body 11, the first via conductor 21a may be exposed thereto.

The second via conductor 21b is provided inside the capacitor body 11 in such a way as to extend in the first direction Y1, and is electrically coupled to the multiple second inner electrodes 13b. The second via conductor 21b penetrates the first through holes 131 provided to the first inner electrodes 13a, and is insulated from the first inner electrodes 13a.

The second via conductor 21b is exposed to at least the first principal surface 15a of the capacitor body 11. Although FIGS. 15 and 16 illustrate a configuration in which the second via conductor 21b is not exposed to the second principal surface 15b of the capacitor body 11, the second via conductor 21b may be exposed thereto.

A material of the first via conductor 21a and the second via conductor 21b is arbitrarily determined. Examples of the material include a metal such as Ni, Cu, Ag, Pd, Pt, Fe, Ti, Cr, Sn, or Au, or an alloy containing any of these metals, and the like.

The first outer electrode 14a is provided at a position where the first via conductor 21a is exposed to the first principal surface 15a of the capacitor body 11, and is electrically coupled to the first via conductor 21a. Since the first via conductor 21a is electrically coupled to the multiple first inner electrodes 13a, the first outer electrode 14a is electrically coupled to the multiple first inner electrodes 13a.

The second outer electrode 14b is provided at a position where the second via conductor 21b is exposed to the first principal surface 15a of the capacitor body 11, and is electrically coupled to the second via conductor 21b. Since the second via conductor 21b is electrically coupled to the multiple second inner electrodes 13b, the second outer electrode 14b is electrically coupled to the multiple second inner electrodes 13b.

The first outer electrode 14a and the second outer electrode 14b are not provided on the second principal surface 15b of the capacitor body 11 in the multilayer ceramic capacitor 10C according to the present example embodiment. The multilayer ceramic capacitor 10C according to the fourth example embodiment can therefore reduce or prevent the occurrence of cracks when carrying out the ultrasonic joining as with the multilayer ceramic capacitor 10 according to the first example embodiment.

The multilayer ceramic capacitor 10C according to the fourth example embodiment can be manufactured in accordance with the same or substantially the same method used for the multilayer ceramic capacitor 10A according to the second example embodiment and the multilayer ceramic capacitor 10B according to the third example embodiment. However, a process to form the first via conductor 21a and the second via conductor 21b is required.

For this reason, after the mother multilayer body is fabricated in accordance with the same or substantially the same method as the manufacturing method of the multilayer ceramic capacitor 10A according to the second example embodiment and the multilayer ceramic capacitor 10B according to the third example embodiment, a through hole for forming the first via conductor 21a and a through hole for forming the second via conductor 21b are formed. The through holes are formed by irradiation of a laser beam, for example.

Subsequently, the through holes thus formed are filled with a conductive paste for forming the first via conductor 21a and the second via conductor 21b. Thereafter, the mother multilayer body is successively subjected to the pressing process and the process to be cut into the predetermined size as with the manufacturing method of the multilayer ceramic capacitor 10A according to the second example embodiment and the multilayer ceramic capacitor 10B according to the third example embodiment.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a capacitor body including:
a plurality of dielectric layers;
a plurality of first inner electrodes;
a plurality of second inner electrodes;
a first principal surface and a second principal surface opposed to each other in a first direction;
a first side surface and a second side surface opposed to each other in a second direction orthogonal or substantially orthogonal to the first direction; and
a first end surface and a second end surface opposed to each other in a third direction orthogonal or substantially orthogonal to the first direction and the second direction;
a first outer electrode on at least the first principal surface, and electrically coupled to the first inner electrodes;
a second outer electrode on at least the first principal surface, and electrically coupled to the second inner electrodes;
a first bump on a surface on a first principal surface side of the capacitor body, and including one of Au, Cu, or Al; and
a second bump on a surface on the first principal surface side of the capacitor body, and including a same material as the first bump; wherein
the first outer electrode and the second outer electrode are not provided on the second principal surface of the capacitor body;
the first outer electrode includes a first metal layer on at least a position that comes into contact with the first bump, and includes the same material as the first bump;
the second outer electrode includes a second metal layer on at least a position that comes into contact with the second bump, and includes the same material to the second bump; and
a thickness of the first bump and a thickness of the second bump in the first direction are equal to or greater than about 4.5 μm.

2. The multilayer ceramic capacitor according to claim 1, wherein thicknesses of the first metal layer and the second metal layer are equal to or greater than about 0.3 μm.

3. The multilayer ceramic capacitor according to claim 1, wherein a proportion of an area of a flat region of the second principal surface of the capacitor body relative to an area of the second principal surface is equal to or greater than about 0.8.

4. The multilayer ceramic capacitor according to claim 1, wherein a Young's modulus of the capacitor body is equal to or greater than about 67 GPa.

5. The multilayer ceramic capacitor according to claim 1, wherein the first outer electrode and the second outer electrode are provided only on the first principal surface of the capacitor body.

6. The multilayer ceramic capacitor according to claim 1, wherein
the first outer electrode is provided on the first principal surface and the first end surface; and
the second outer electrode is provided on the first principal surface and the second end surface of the capacitor body.

7. The multilayer ceramic capacitor according to claim 1, wherein
the first outer electrode is provided on the first principal surface, the first end surface, the first side surface, and the second side surface of the capacitor body; and
the second outer electrode is provided on the first principal surface, the second end surface, the first side surface, and the second side surface of the capacitor body.

8. The multilayer ceramic capacitor according to claim 1, wherein each of the plurality of dielectric layers includes BaTiO₃, CaTiO₃, SrTiO₃, SrZrO₃, or CaZrO₃ as a major component.

9. The multilayer ceramic capacitor according to claim 8, wherein each of the plurality of dielectric layers includes a Mn compound, a Fe compound, a Cr compound, a Co compound, or a Ni compound in a smaller amount than the major component.

10. The multilayer ceramic capacitor according to claim 1, wherein each of the plurality of first inner electrodes and the plurality of second inner electrodes includes Ni, Ag, Pd, Au, Cu, Ti, or Cr, or an alloy including any of Ni, Ag, Pd, Au, Cu, Ti, or Cr as a major component.

11. The multilayer ceramic capacitor according to claim 10, wherein each of the plurality of first inner electrodes and the plurality of second inner electrodes includes a same material as the plurality of dielectric layers.

12. The multilayer ceramic capacitor according to claim 11, wherein a content percentage of the same material is each of the plurality of first inner electrode layers and the plurality of second inner electrode layers is about 20% by volume or less.

13. The multilayer ceramic capacitor according to claim 1, wherein
the first outer electrode includes a first foundation electrode layer and the first metal layer on the first foundation electrode layer; and
the second outer electrode includes a second foundation electrode layer and the second metal layer on the second foundation electrode layer.

14. The multilayer ceramic capacitor according to claim 13, wherein each of the first and second foundation electrode layers is a baked electrode layer including glass and a metal.

15. The multilayer ceramic capacitor according to claim 14, wherein the metal includes Cu, Ni, Ag, Pd, Ti, Cr, or Au, or an alloy including any of Cu, Ni, Ag, Pd, Ti, Cr, or Au.

16. The multilayer ceramic capacitor according to claim 13, wherein each of the first and second foundation electrode layers is a resin electrode layer.

17. The multilayer ceramic capacitor according to claim 13, wherein each of the first and second foundation electrode layers is a thin film electrode layer.

18. The multilayer ceramic capacitor according to claim 17, wherein the thin film electrode layer has a thickness of equal to or less than about 1 μm.
